(19) United States
(12) Patent Application Publication
(10) Pub. No.: US 2002/0106467 A1
(43) Pub. Date: Aug. 8, 2002

(54) Storage case for magnetic tape cassette

(75) Inventors: Akihiko Fujii, Kanagawa (JP); Katsuki Asano, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/066,580

(22) Filed: Feb. 6, 2002

(30) Foreign Application Priority Data
Feb. 7, 2001 (JP) P. 2001-031145

(51) Int. Cl. B65D 85/575; B32B 1/02

(52) U.S. Cl. 428/35.7; 206/387.1

(57) ABSTRACT

A storage case for a magnetic tape cassette according to the invention is formed of resin material which is transparent to such an extent that an interior of the storage case is visible, and a metallocene catalyst is added to the resin material to such an extent that its strength against a drop shock is substantially equal to that of a colored storage case. Thus, it is possible to provide the storage case for the magnetic tape cassette which can be enhanced in the transparency while maintaining the strength, and is unlikely to be broken.

### BACKGROUND OF THE INVENTION

The present invention relates to a storage case for a magnetic tape cassette.

As a recording medium, there have been conventionally used various types of magnetic tape cassettes. Generally, in audio apparatuses and video apparatuses, a magnetic tape cassette of a type which has a pair of tape reels with a magnetic tape has been used. The pair of the tape reels, around which the magnetic tape is wounded, are rotatably held inside a cassette case comprising of an upper cassette half and a lower cassette half. On the other hand, in a computer or the like, a magnetic tape cassette which has a single tape reel has been used. The single tape reel, around which a magnetic tape is wounded, is rotatably held in a cassette case of one reel type.

These magnetic tape cassettes are respectively contained in storage cases to be carried and stored so that they can be protected from dust or a shock in the event of dropping.

Some of the storage cases are made of resin material such as polypropylene, and generally called as “hard cases”. In order to increase transparency of the storage case, a nucleating agent is added to the resin material for the storage case.

The storage case molded of the resin material to which the nucleating agent has been added is inferior in strength against a drop shock and is likely to be cracked or chipped, although excellent appearance in transparency.

However, thickening walls of the storage case to improve the strength of the storage case is undesirable, because this may deteriorate weight saving and cost reduction, and may not meet the needs of users. In case where rubber is added alternatively, there has been a problem that its transparency may decrease.

### SUMMARY OF THE INVENTION

The present invention has been made in view of such circumstances, and an object of the invention is to provide a storage case for a magnetic tape cassette which can be enhanced in transparency while maintaining its strength, and which is unlikely to be broken.

The above described object of the invention can be achieved by a storage case for a magnetic tape cassette formed of resin material which is transparent to such an extent that an interior of the storage case is visible, and the resin material includes a metallocene catalyst to provide strength for the storage case, wherein the metallocene catalyst is added to the resin material to such an extent that its strength against a drop shock is substantially equal to that of a colored storage case which is formed of resin material.

For example, the object can also be attained by the storage case for the magnetic tape cassette which is molded of the material such as the transparent or translucent resin material added with 5 to 25 mass % of metallocene catalyst. Preferably, 10 to 15 mass % of the metallocene catalyst may be added to the transparent or translucent resin material. In this way, a balance between the strength to be maintained and the transparency to be enhanced can be optimized.

In this case, as the transparent or translucent resin material, polyethylene, polypropylene, and like that, can be raised as examples, but the resin material is not particularly limited to them.

As the metallocene catalyst, metallocene-polyethylene or the like can be employed, but the catalyst is not particularly limited to them.

According to the storage case for the magnetic tape cassette having the above described composition, the transparency can be enhanced, while the strength is maintained at the substantially same level as the colored storage case which is formed of resin material. Moreover, by keeping the walls of the storage case thin, it is possible to attain weight saving and cost reduction, and flexibility of design can be also enhanced.

### BRIEF DESCRIPTION OF THE DRAWINGS

FIG. 1 is a perspective view of a storage case for a magnetic tape cassette according to a first embodiment of the invention;

FIG. 2 is a perspective view of a storage case for the magnetic tape cassette according to a second embodiment of the invention; and

FIG. 3 is a graph for explaining effects of an example of the storage case for the magnetic tape cassette according to the invention.

### DESCRIPTION OF THE PREFERRED EMBODIMENTS

Now, embodiments of the invention will be described in detail referring to the drawings.

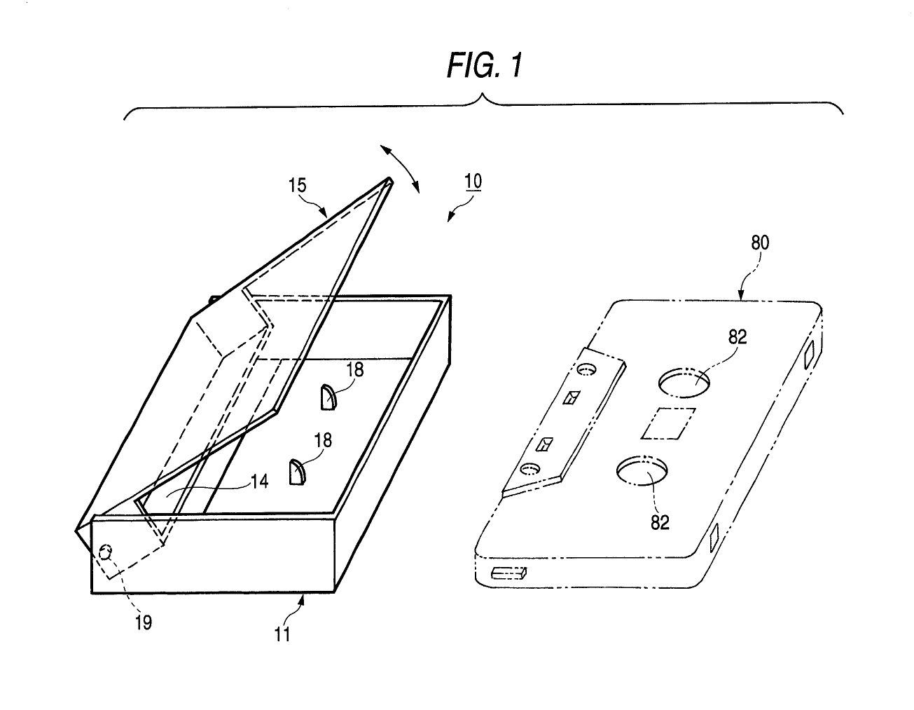

FIG. 1 is a perspective view of a storage case for a magnetic tape cassette according to a first embodiment of the invention. A cassette 80 for an audio apparatus is adapted to be contained in this storage case 10 for the magnetic tape cassette.

This storage case 10 includes a lid part 15 provided with a pocket 14 which can receive a part of the cassette 80, and a casing part 11 provided with a pair of rotation preventing projections 18 which are adapted to enter into shafts insertion holes 82 in the cassette 80. The casing part 11 and the 11d part 15 are connected to each other so as to be opened and closed, by engaging support shafts 19 projectingly provided on inner faces of both side walls of the casing part 11 with holes formed in both side walls of the pocket 14.

This storage case 10 is molded of the material consisting of transparent or translucent polypropylene which contains no pigment, and 5 to 25 mass % of metallocene-polyethylene added thereto.

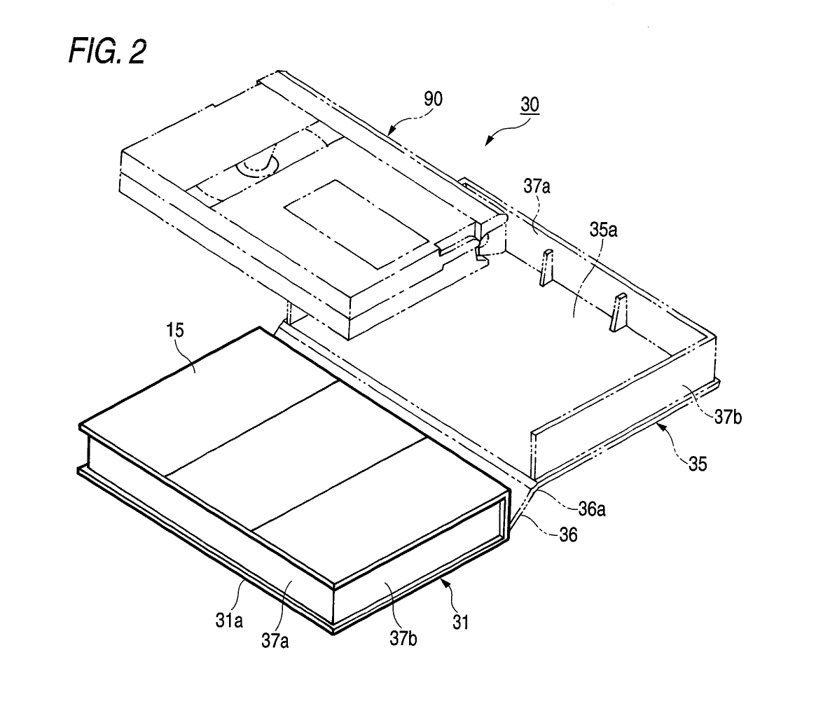

FIG. 2 is a perspective view of a storage case 30 for a magnetic tape cassette according to the second embodiment of the invention. A digital video cassette (DVC) 90 of D3 type, as the magnetic tape cassette for commercial use, is adapted to be contained in this storage case 30 for the magnetic tape cassette.

This storage case 30 includes a holding part 31, and a lid part 35 which is connected to the holding part 31 so as to be folded through a connecting piece 36 and a thin-walled hinge 36a.

The lid part 35 has a top plate 35a which has the same shape and the same area as a rectangular bottom plate 31a of the holding part 31. An end wall 37a is provided on a longer edge of the top plate 35a at an opposite side to an edge connected to the thin-walled hinge 36a. Side walls 37b are provided on both short edges of the top plate 35a.

This storage case 30 is also molded of the material consisting of transparent or translucent polypropylene which contains no pigment, and from 5 mass % to 25 mass % of metallocene-polyethylene added thereto.

### EXAMPLE

90 Pieces of the storage cases for the magnetic tape cassettes in a form as shown in FIG. 2 and molded of polyethylene added with from 10 mass % to 15 mass % of metallocene catalyst (Example) have been prepared. When 30 pieces each of these storage cases were dropped from determined heights (0.5 m, 1 m, and 1.5 m), conditions of cracks, chips, stroke marks occurred in each of the storage cases have been examined.

For comparison, 90 pieces of the conventional storage cases molded of translucent polypropylene (Comparative Example 1, clear cases) have been prepared, and subjected to the drop test in the same manner as the example.

Also for comparison, 90 pieces of the conventional colored storage cases molded of polypropylene added with a pigment (Comparative Example 2, gray cases) have been prepared, and subjected to the drop test in the same manner as the example.

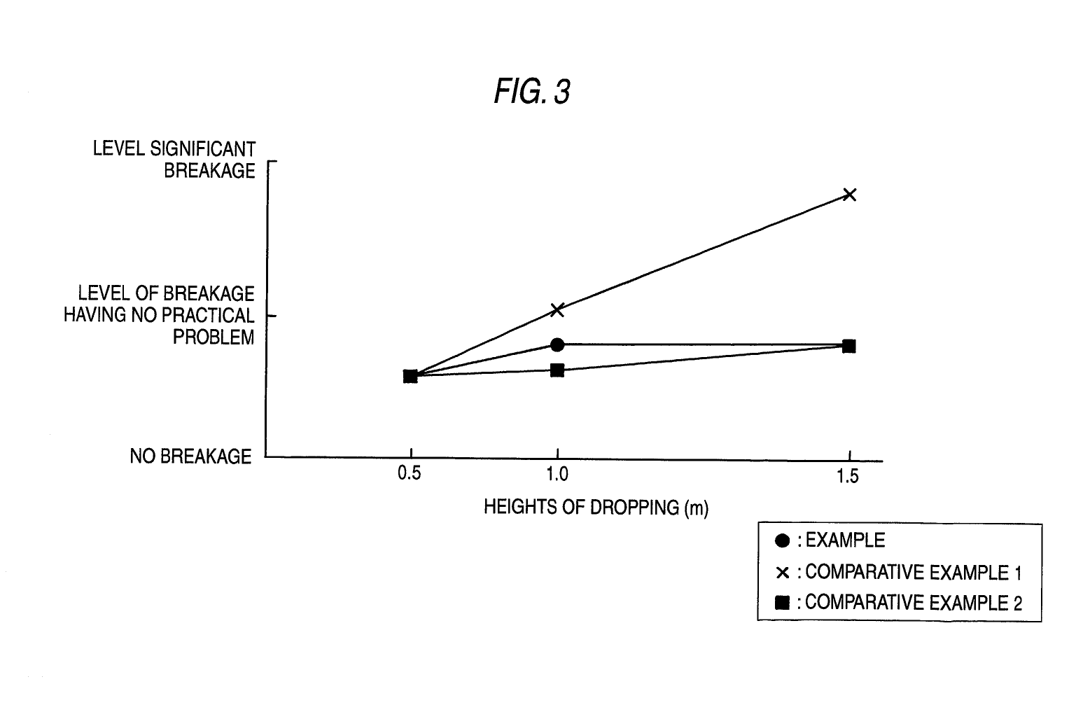

The results are shown in FIG. 3. As apparent from FIG. 3, the example of the invention has the strength against a drop substantially equal to the conventional gray case (Comparative Example 2), and has remarkably increased in the strength as compared with the conventional clear case (Comparative Example 1).

It is to be noted that the present invention is not limited to the above described embodiments nor to the example, but appropriate modifications and changes can be made.

For example, the invention can be also applied to the storage case for the magnetic tape cassette for a computer.

As described herein above, according to the invention, it is possible to provide the storage case for the magnetic tape cassettes which can be enhanced in the transparency while maintaining the strength, and is unlikely to be broken.

While only certain embodiments of the invention have been specifically described herein, it will apparent that numerous modifications may be made thereto without departing from the spirit and scope of the invention.

What is claimed is:

1. A storage case for a magnetic tape cassette, wherein the storage case is formed of resin material which is transparent to such an extent that an interior of the storage case is visible, and the resin material includes a metallocene catalyst to provide strength for the storage case.

2. The storage case for a magnetic tape cassette as set forth in claim 1, wherein the metallocene catalyst is added to the resin material with from 5 mass % to 25 mass %.

3. The storage case for a magnetic tape cassette as set forth in claim 2, wherein the metallocene catalyst is added to the resin material with from 10 mass % to 15 mass %.

4. The storage case for a magnetic tape cassette as set forth in claim 1, wherein the metallocene catalyst is metallocene-polyethylene.

5. The storage case for a magnetic tape cassette as set forth in claim 4, wherein the metallocene-polyethylene is added to the resin material with from 5 mass % to 25 mass %.

6. The storage case for a magnetic tape cassette as set forth in claim 5, wherein the metallocene-polyethylene is added to the resin material with from 10 mass % to 15 mass %.
